(19) United States
(12) Patent Application Publication
(10) Pub. No.: US 2003/0121203 A1
(43) Pub. Date: Jul. 3, 2003

(54) Gardening ornament frame

(76) Inventor: Chen-Hsiung Lin, Taichung (TW)

Correspondence Address: Chen-Hsiung Lin, 58, MA YUAN WEST ST., TAICHUNG, TW

(21) Appl. No.: 10/357,254

(22) Filed: Jan. 29, 2003

Related U.S. Application Data
(63) Continuation-in-part of application No. 09/950,355, filed on Sep. 5, 2001, now abandoned.

(51) Int. Cl. A01G 17/06; A01G 17/14

(52) U.S. Cl. 47/47

(57) ABSTRACT

A gardening ornament frame includes a first half netting, a first hollow leg integrally formed on and extending downward from a bottom of the first half netting, a second half netting combined with the first half netting, and a second hollow legs integrally formed on and extending downward from a bottom of the second half netting. Thus, the gardening ornament frame has a predetermined configuration of the animal shape, so that when the plants are grown up, the plants are forced to form the predetermined configuration of the animal shape by confinement of the gardening ornament frame, thereby enhancing the aesthetic quality of the plants.

### CROSS-REFERENCES TO RELATED APPLICATIONS

The present invention is a continuation-in-part application of the co-pending U.S. Ser. No. 09/950,355, filed on Sep. 5, 2001, now abandoned.

### BACKGROUND OF THE INVENTION

1. Field of the Invention

The present invention relates to a gardening ornament frame, and more particularly to a gardening ornament frame that is formed with a predetermined configuration of the animal shape, so that when the plants are grown up, the plants are forced to form the predetermined configuration of the animal shape by confinement of the gardening ornament frame, thereby enhancing the aesthetic quality of the plants.

2. Description of the Related Art

The closest prior art of which the applicant is aware is disclosed in U.S. Pat. No. 1,544,322 to Kellermann, entitled “METHOD OF HEADING LETTUCE”. The Kellermann reference disclosed a lettuce header comprising two hollow members A and B (page 1 lines 56-58). The edges of the two hollow members A and B are attached to a binding strip C (page 1 lines 64-65). Each of the two hollow members A and B has a circular opening at the bottom for reception of the neck of the plant (page 1 lines 68-70). The material about the opening is secured to a binder D (page 1 lines 70-72). A hinge E connects the two hollow members A and B in the manner as shown in FIG. 1 (page 1 lines 72-73). A hook F is mounted on the side opposite from the hinge E for holding the two hollow members A and B (page 1 lines 75-76).

### SUMMARY OF THE INVENTION

The primary objective of the present invention is to provide a gardening ornament frame that is formed with a predetermined configuration of the animal shape, so that when the plants are grown up, the plants are forced to form the predetermined configuration of the animal shape by confinement of the gardening ornament frame, thereby enhancing the aesthetic quality of the plants.

Another objective of the present invention is to provide a gardening ornament frame, wherein the part of the plants protruding outward from the gardening ornament frame can be cut and trimmed easily and conveniently, thereby facilitating the user trimming the plants.

In accordance with the present invention, there is provided a gardening ornament frame, comprising:

a first half netting;

a first hollow leg integrally formed on and extending downward from a bottom of the first half netting, the first hollow leg having a bottom formed with a first opening;

a second half netting combined with the first half netting; and

a second hollow legs integrally formed on and extending downward from a bottom of the second half netting, the second hollow leg having a bottom formed with a second opening.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a gardening ornament frame in accordance with the first embodiment of the present invention;

FIG. 1A is a partially cut-away enlarged view of the gardening ornament frame as shown in FIG. 1;

FIG. 2 is an exploded perspective view of the gardening ornament frame in accordance with the first embodiment of the present invention;

FIG. 3 is a perspective view of the application of the gardening ornament frame in accordance with the first embodiment of the present invention;

FIG. 4 is a perspective view of a gardening ornament frame in accordance with the second embodiment of the present invention;

FIG. 4A is a partially cut-away enlarged view of the gardening ornament frame as shown in FIG. 1;

FIG. 5 is an exploded perspective view of the gardening ornament frame in accordance with the second embodiment of the present invention; and

FIG. 6 is a perspective view of the application of the gardening ornament frame in accordance with the second embodiment of the present invention.

### DETAILED DESCRIPTION OF THE INVENTION

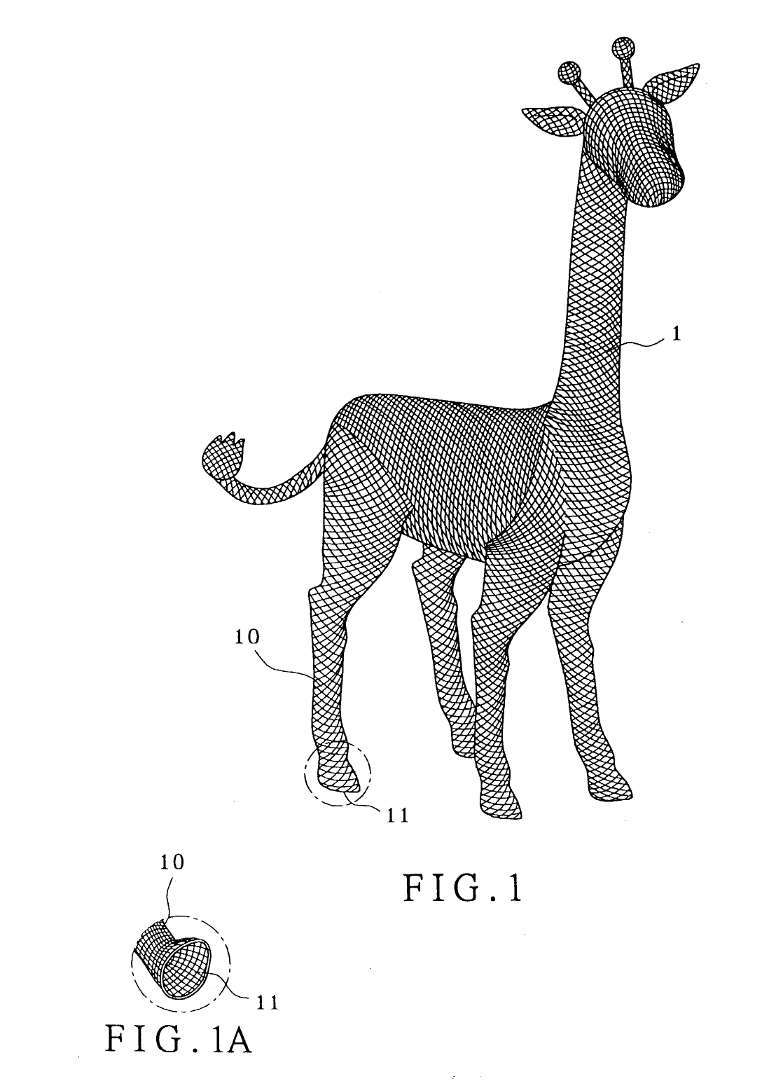

Referring to the drawings and initially to FIGS. 1-3, a gardening ornament frame 1 in accordance with the first embodiment of the present invention comprises a first half netting 12, two first hollow legs 10 each integrally formed on and extending downward from a bottom of the first half netting 12, a second half netting 13 combined with the first half netting 12, and two second hollow legs 10′ each integrally formed on and extending downward from a bottom of the second half netting 13. The first halfnetting 12 has a first periphery 121, and the second half netting 13 has a second periphery 131 matching the first periphery 121 of the first half netting 12. Each first hollow leg 10 has a bottom formed with a first opening 11, and each second hollow leg 10′ has a bottom formed with a second opening 11′.

In such a manner, the second half netting 13 is combined with the first half netting 12 to form the gardening ornament frame 1 as shown in FIG. 1. In addition, the gardening ornament frame 1 is formed with a predetermined configuration with the animal shape, such as the giraffe or with the plant shape.

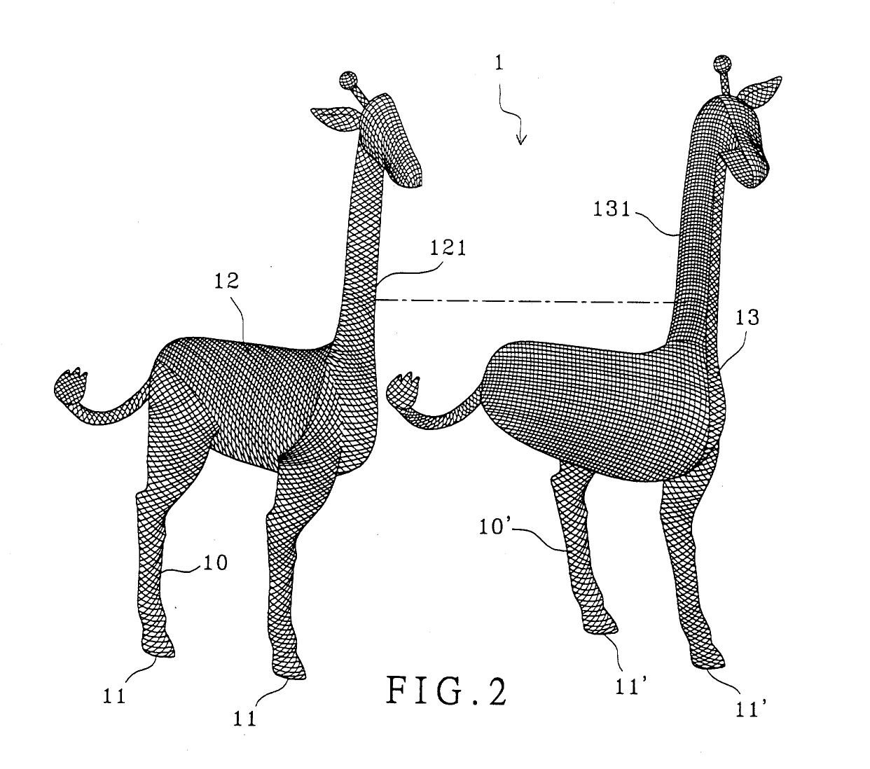

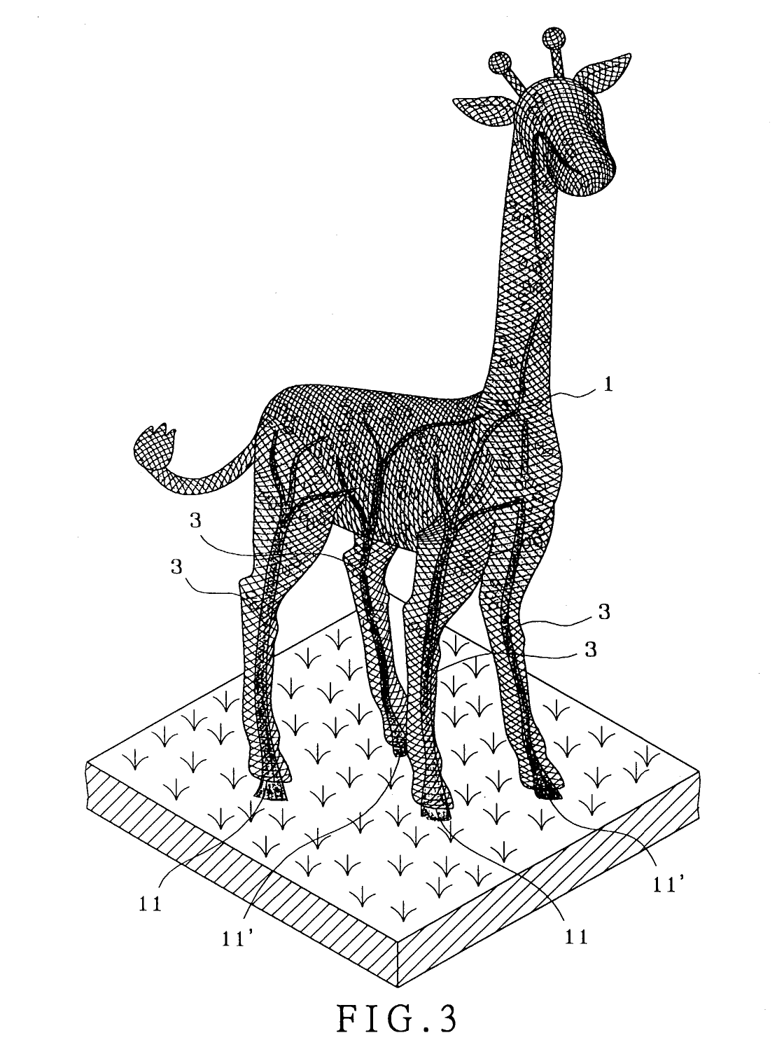

As shown in FIGS. 2 and 3, the plants 3 are placed into the first hollow leg 10 and the second hollow leg 10′ through the first opening 11 and the second opening 11′. When the plants 3 are grown up, the plants 3 are confined in the inner space of the gardening ornament frame 1 defined by the first half netting 12 and the second half netting 13. The part of the plants 3 protruding outward from the gardening ornament frame 1 can be cut and trimmed, so that the gardening ornament frame 1 is kept at a clean and smooth state.

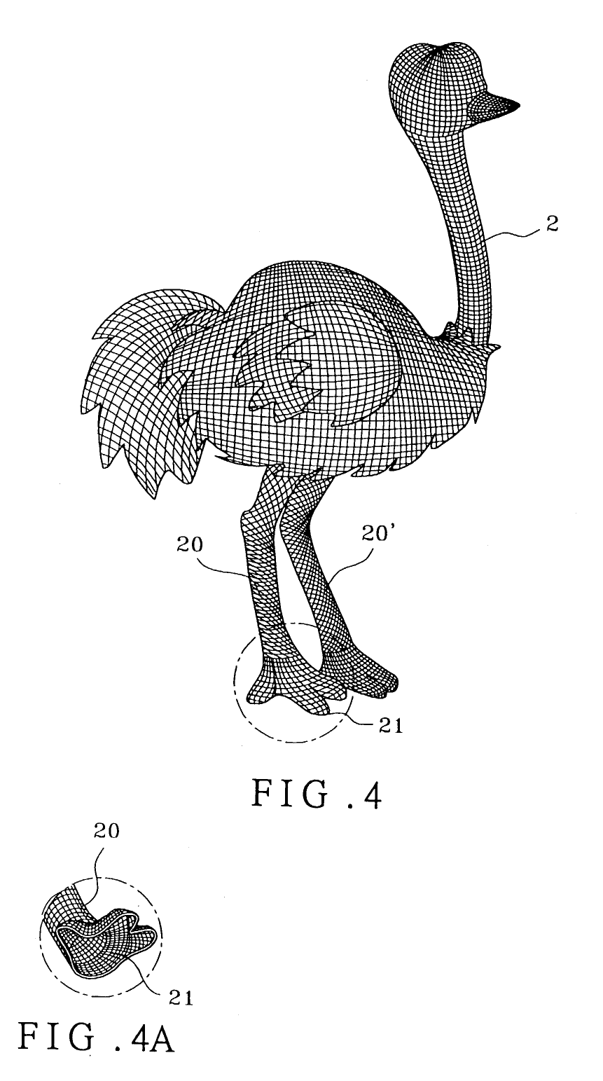

Referring to FIGS. 4-6, a gardening ornament frame 2 in accordance with the second embodiment of the present invention comprises a first half netting 22, a first hollow leg 20 integrally formed on and extending downward from a bottom of the first half netting 22, a second half netting 23 combined with the first half netting 22, and a second hollow legs 20′ integrally formed on and extending downward from a bottom of the second half netting 23. The first half netting 22 has a first periphery 221, and the second half netting 23 has a second periphery 231 matching the first periphery 221 of the first half netting 22. The first hollow leg 20 has a bottom formed with a first opening 21, and the second hollow leg 20′ has a bottom formed with a second opening 21′.

In such a manner, the second half netting 23 is combined with the first half netting 22 to form the gardening ornament frame 2 as shown in FIG. 4. In addition, the gardening ornament frame 2 is formed with a predetermined configuration with the animal shape, such as the ostrich or with the plant shape.

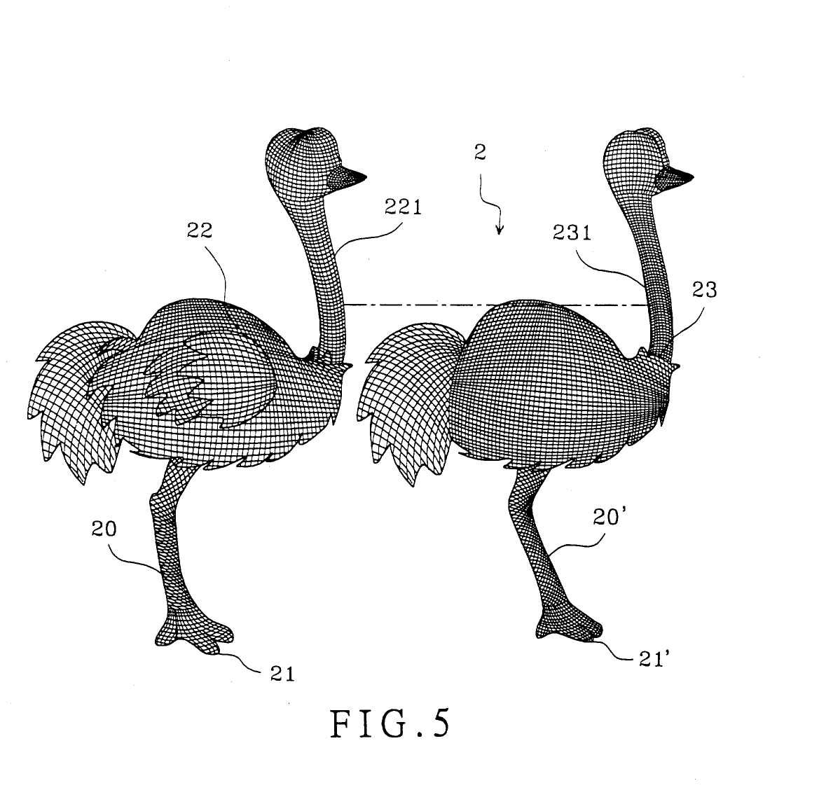

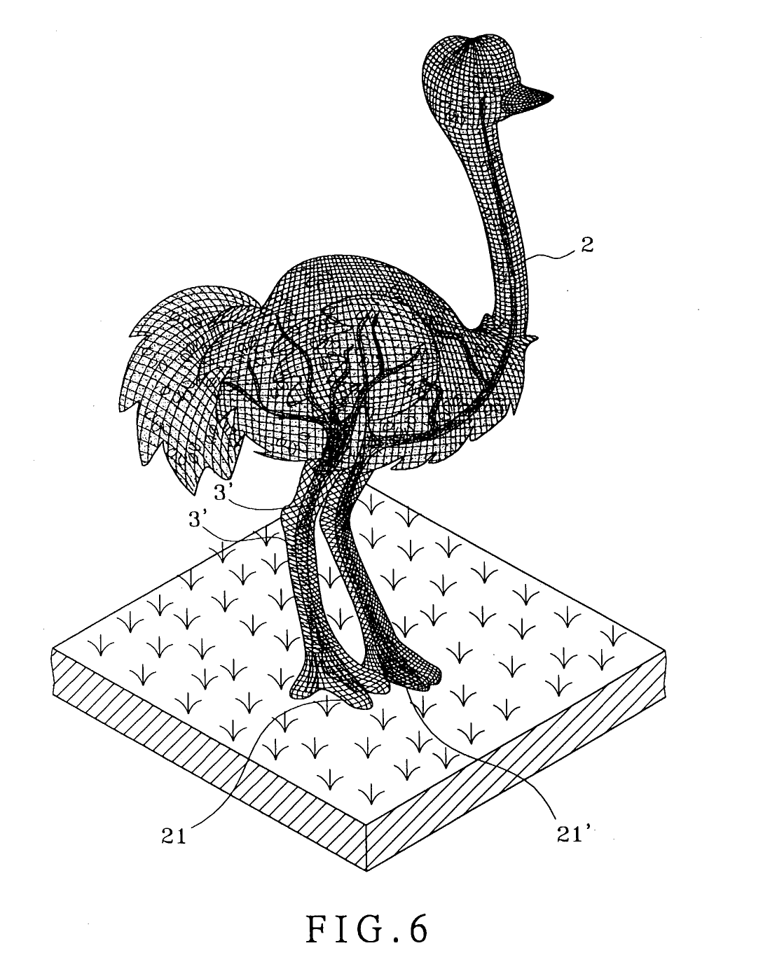

As shown in FIGS. 5 and 6, the plants 3′ are placed into the first hollow leg 20 and the second hollow leg 20′ through the first opening 2—and the second opening 21′. When the plants 3′ are grown up, the plants 3′ are confined in the inner space of the gardening ornament frame 2 defined by the first half netting 22 and the second half netting 23. The part of the plants 3′ protruding outward from the gardening ornament frame 2 can be cut and trimmed, so that the gardening ornament frame 2 is kept at a clean and smooth state.

Accordingly, the gardening ornament frame is formed with a predetermined configuration of the animal shape, so that when the plants are grown up, the plants are forced to form the predetermined configuration of the animal shape by confinement of the gardening ornament frame, thereby enhancing the aesthetic quality of the plants. In addition, the part of the plants protruding outward from the gardening ornament frame can be cut and trimmed easily and conveniently, thereby facilitating the user trimming the plants.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A gardening ornament frame, comprising:
a first half netting;
a first hollow leg integrally formed on and extending downward from a bottom of the first half netting, the first hollow leg having a bottom formed with a first opening;
a second half netting combined with the first half netting; and
a second hollow legs integrally formed on and extending downward from a bottom of the second half netting, the second hollow leg having a bottom formed with a second opening.

2. The gardening ornament frame in accordance with claim 1, wherein the first half netting has a first periphery, and the second half netting has a second periphery matching the first periphery of the first half netting.

3. The gardening ornament frame in accordance with claim 1, wherein the first half netting has a predetermined half configuration and the second half netting has a predetermined half configuration, so that the first half netting and the second half netting are combined with each other to form the gardening ornament frame having a predetermined whole configuration.

4. The gardening ornament frame in accordance with claim 1, wherein the first half netting and the second half netting are combined with each other to form the gardening ornament frame having a giraffe shape.

5. The gardening ornament frame in accordance with claim 1, wherein the first half netting and the second half netting are combined with each other to form the gardening ornament frame having an ostrich shape.
